(19) United States
(12) Patent Application Publication
(10) Pub. No.: US 2020/0067076 A1
(43) Pub. Date: Feb. 27, 2020

(54) MATERIALS FOR LITHIUM-ION ELECTROCHEMICAL CELLS AND METHODS OF MAKING AND USING SAME

(71) Applicant: 3M INNOVATIVE PROPERTIES COMPANY, St. Paul, MN (US)

(72) Inventors: Tianyu Wu, Woodbury, MN (US); Mark J. Pellerite, Woodbury, MN (US); Klaus Hintzer, Kastl (DE)

(21) Appl. No.: 16/609,344

(22) PCT Filed: May 9, 2018
(86) PCT No.: PCT/IB2018/053231

§ 371 Date: Oct. 29, 2019

Related U.S. Application Data
(60) Provisional application No. 62/506,246, filed on May 15, 2017.

(51) Int. Cl. H01M 4/134; H01M 4/62; H01M 4/36; H01M 4/38; H01M 4/133; H01M 10/0525

(52) U.S. Cl. CPC H01M 4/134; H01M 4/623; H01M 4/364; H01M 2004/027; H01M 4/386; H01M 4/133; H01M 10/0525; H01M 4/366

(57) ABSTRACT

A negative electrode material includes a silicon containing material; and a composition that includes (i) a first (co)polymer derived from polymerization of two or more monomers comprising tetrafluoroethylene, hexafluoropropylene, vinylidene fluoride, or chlorotrifiuorethylene; and (ii) a second (co)polymer derived from polymerization of monomers comprising (meth)acrylic acid or lithium (meth)acrylate.

### FIELD

The present disclosure relates to compositions useful in negative electrodes for electrochemical cells (e.g, lithium ion batteries) and methods for preparing and using the same.

### BACKGROUND

Various components have been introduced for use in the negative electrodes of lithium-ion batteries. Such components are described, for example, in U.S. Pat. Nos. 8,354,189, 7,875,388, and M. N. Obrovac and V. L. Chevrier, Chemical Reviews 2014, 114, 11444-11502.

### SUMMARY

In some embodiments, a negative electrode material is provided. The materials includes a silicon containing material; and a composition that includes (i) a first (co)polymer derived from polymerization of two or more monomers comprising tetrafluoroethylene, hexafluoropropylene, vinylidene fluoride, or chlorotrifluorethylene; and (ii) a second (co)polymer derived from polymerization of monomers comprising (meth)acrylic acid or lithium (meth)acrylate.

The above summary of the present disclosure is not intended to describe each embodiment of the present disclosure. The details of one or more embodiments of the disclosure are also set forth in the description below. Other features, objects, and advantages of the disclosure will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIG. 1 is a graph of results of electrochemical cycling for lithium half-cells prepared using negative electrode materials of the present disclosure and comparative negative electrode materials.

### DETAILED DESCRIPTION

Electrochemical energy storage has become a critical technology for a variety of applications, including grid storage, electric vehicles, and portable electronic devices. Lithium-ion battery (LIB) is a viable electrochemical energy storage system because of its relatively high energy density and good rate capability. In order for industry relevant battery applications, such as electric vehicles, to be commercially viable on a large scale, it is desirable for the cost of the lithium ion battery chemistry to be lowered.

High-energy-density anode materials based on silicon have been identified as a means to reduce cost and improve energy density of lithium ion batteries for applications such as electric vehicles and handheld electronics. Certain silicon alloy materials offer good particle morphology (optimized particle size, low surface area) and high first-cycle efficiency, resulting in higher-energy cells (based on both volumetric (Wh/L) and weight (Wh/kg) energy density). The anode binder also plays a key role in maximizing the performance of a lithium cell containing anodes based on silicon alloy or blends of silicon alloy with graphite. In order to achieve maximum Wh/L, the weight percent of silicon alloy in the anode should be maximized and the weight percent of binder in the anode should be reduced.

Certain silicon alloys, for example, with capacities greater than 1100 mAh/gram and densities of approximately 3.4 g/cc, undergo significant volume change (up to approximately 140% or more) during charge and discharge cycles. Binders typically used with graphite anodes, such as poly(vinylidene fluoride) and styrene-butadiene-styrene/sodium carboxymethyl-cellulose (SBS/Na-CMC), are not viable choices for use in anodes containing more than about 15 wt % silicon alloy, because these materials are unable to tolerate this extent of volume expansion in the electrode. Batteries made with anodes incorporating these binders show very poor capacity retention.

The lithium salt of poly(acrylic acid) (LiPAA) has shown promising cycle life performance as a binder for silicon alloy based anodes, especially at higher alloy content (for example, greater than about 20% alloy in a graphite/silicon alloy anode formulation). However, LiPAA has been observed as too brittle or too hygroscopic to be processed as an effective binder for some in the industry. LiPAA also exhibits insufficient adhesion to anode (copper foil) current collectors. Thus, there exists a need for the development of new anode materials that will enable use of high-capacity anode materials such as silicon alloy in the next generation of lithium-ion batteries. The developed materials should be scalable and economical from a processing and raw materials cost perspective, and should be insoluble in conventional battery electrolytes.

It has been discovered that blends of poly(acrylic acid) of certain molecular weight and certain fluoropolymers can be prepared that function as a material (e.g., binder) for silicon alloy anodes. Anodes including these blends were found to exhibit capacity retention as a function of charge/discharge cycle equivalent or nearly so to that for anodes prepared using neat lithium polyacrylate. Furthermore, replacement of as much as about 50 weight percent of the polar, hydrophilic poly((meth)acrylic acid) with certain hydrophobic fluoropolymers introduces other benefits such as improved mechanical flexibility (decreased brittleness) of the material and greatly reduced moisture uptake.

Regarding the above discussed cycle performance of batteries having negative electrodes that include the blends of the present disclosure, such performance is surprising at least because when used alone, the fluoropolymer components of the blend (as well as other known fluoropolymers such as poly(vinylidene fluoride)) exhibit very poor performance as negative electrode components. Furthermore, the discovery that poly(acrylic acid) of certain molecular weights blend well with the fluoropolymer components without precipitation represents an additional surprising result.

As used herein,

the term “(co)polymer” refers to homo- or copolymers;

the term “(meth)acrylic acid” refers to acrylic acid or methacrylic acid;

the term “(meth)acrylate” refers to acrylate or methacrylate;

the terms “lithiate” and “lithiation” refer to a process for adding lithium to an electrode material or electrochemically active phase;

the terms “delithiate” and “delithiation” refer to a process for removing lithium from an electrode material or electrochemically active phase;

the terms “charge” and “charging” refer to a process for providing electrochemical energy to a cell;

the terms “discharge” and “discharging” refer to a process for removing electrochemical energy from a cell, e.g., when using the cell to perform desired work;

the phrase “charge/discharge cycle” refers to a cycle wherein an electrochemical cell is fully charged, i.e. the cell attains its upper cutoff voltage and the anode is at about 100% state of charge, and is subsequently discharged to attain a lower cutoff voltage and the anode is at about 100% depth of discharge;

the phrase “positive electrode” refers to an electrode (often called a cathode) where electrochemical reduction and lithiation occurs during a discharging process in a full cell;

the phrase “negative electrode” refers to an electrode (often called an anode) where electrochemical oxidation and delithiation occurs during a discharging process in a full cell;

the phrase “electrochemically active material” refers to a material, which can include a single phase or a plurality of phases, that can electrochemically react or alloy with lithium under conditions possibly encountered during charging and discharging in a lithium ion battery (e.g., voltages between 0 V and 2 V versus lithium metal);

the term “alloy” refers to a substance that includes chemical bonding between any or all of metals, metalloids, or semimetals;

the phrase “catenated heteroatom” means an atom other than carbon (for example, oxygen, nitrogen, or sulfur) that is bonded to carbon atoms in a carbon chain so as to form a carbon-heteroatom-carbon chain; and

As used herein, the term “neat” means a composition of essentially 100% of a material without diluents, solvents, or additives.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

In some embodiments, the present disclosure relates to electrode compositions suitable for use in secondary lithium electrochemical cells (e.g., lithium ion batteries). Generally, the electrode compositions (e.g., negative electrode compositions) may include (i) an electrochemically active material that includes silicon; and (ii) a fluoropolymer/poly((meth)acrylic acid) (PAA) blend.

In some embodiments, the electrochemically active material may include a silicon containing material. The silicon containing material may include elemental silicon, silicon oxide, silicon carbide, or a silicon containing alloy. In some embodiments, the silicon containing material may have a volumetric capacity greater than 1000, 1500, 2000, or 2500 mAh/ml; or a capacity ranging from 1000 to 5500 mAh/ml, 1500 to 5500 mAh/ml, or 2000 to 5000 mAh/ml. For purposes of the present disclosure, volumetric capacity is determined from the true density, measured by Pycnometer, multiplied by the first lithiation specific capacity at C/40 rate to 5 mV versus lithium. This first lithiation specific capacity can be measured by forming an electrode having 90 weight % of the active material and 10% of lithium polyacrylate binder with 1 to 4 mAh/cm², building a cell with lithium metal as the anode and a conventional electrolyte (e.g., 3:7 EC:EMC with 1.0 M LiPF6), lithiating the anode at about a C/10 rate to 5 mV versus lithium, and holding 5 mV to C/40 rate.

In embodiments in which the silicon containing material includes a silicon containing alloy, the silicon containing alloy may have the formula: SiₓM_{y}C_{z}, where x, y, and z represent atomic % values and (a) x+y+z=100%; (b) x>2y+z; (c) x and y are greater than 0; z is equal to or greater than 0; (d) M is iron and optionally one or more metals selected from manganese, molybdenum, niobium, tungsten, tantalum, copper, titanium, vanadium, chromium, nickel, cobalt, zirconium, yttrium, or combinations thereof. In some embodiments, 65%≤x≤85%, 70%≤x≤80%, 72%≤x≤74%, or 75%≤x≤77%; 5%≤y≤20%, 14%≤y≤17%, or 13%≤y≤14%; and 5%≤z≤15%, 5%≤z≤8%, or 9%≤z≤12%. In some embodiments, x, y, and z are greater than 0.

In some embodiments, the alloy material may take the form of particles. The particles may have an average diameter (or length of longest dimension) that is no greater than 60 μm, no greater than 40 μm, no greater than 20 μm, or no greater than 10 μm or even smaller; at least 0.5 μm, at least 1 μm, at least 2 μm, at least 5 μm, or at least 10 μm or even larger; or 0.5 to 10 μm, 1 to 10 μm, 2 to 10 μm, 40 to 60 μm, 1 to 40 μm, 2 to 40 μm, 10 to 40 μm, 5 to 20 μm, 10 to 20 μm, 1 to 30 μm, 1 to 20 μm, 1 to 10 μm, 0.5 to 30 μm, 0.5 to 20 μm, or 0.5 to 10 μm.

In some embodiments the alloy material may take the form of particles having low surface area. The particles may have a surface area that is less than 20 m²/g, less than 12 m²/g, less than 10 m²/g, less than 5 m²/g, less than 4 m²/g, or even less than 2 m²/g.

In some embodiments, each of the phases of the alloy material (i.e., active phase, inactive phase, or any other phase of the alloy material) may include or be in the form of one or more grains. In some embodiments, the Scherrer grain size of each of the phases of the alloy material is no greater than 50 nanometers, no greater than 20 nanometers, no greater than 15 nanometers, no greater than 10 nanometers, or no greater than 5 nanometers. As used herein, the Scherrer grain size of a phase of an alloy material is determined, as is readily understood by those skilled in the art, by X-ray diffraction and the Scherrer equation.

In some embodiments, the electrochemically active material may further include a coating at least partially surrounding the alloy material. By “at least partially surrounding” it is meant that there is a common boundary between the coating and the exterior of the alloy material. The coating can function as a chemically protective layer and can stabilize, physically and/or chemically, the components of the particles. Exemplary materials useful for coatings include carbonaceous materials (e.g., carbon black or graphitic carbon), LiPON glass, phosphates such as lithium phosphate (Li₃PO₄), lithium metaphosphate (LiPO₃), lithium dithionite (Li₂S₂O₄), lithium fluoride (LiF), lithium metasilicate (Li₂SiO₃), and lithium orthosilicate (Li₄SiO₄). The coating can be applied by milling, solution deposition, vapor phase processes, or other processes known to those of ordinary skill in the art. In some embodiments, the coating may include a non-metallic, electrically conductive layer or coating. For example, in some embodiments, the coating may include carbon black. The carbon black may be present in an amount of between 0.01 and 20 wt. %, 0.1 and 10 wt. %, or 0.5 and 5 wt. %, based on the total weight of the alloy material and the carbon black. In such embodiments, the coating may partially surround the alloy material.

In some embodiments, the above-described electrochemically active material may be present in the electrode composition in an amount of between 10 and 99 wt. %, 20 and 98 wt. %, 40 and 98 wt. %, 60 and 98 wt. %, 75 and 95 wt. %, or 85 and 95 wt. %, based on the total weight of the negative electrode composition.

In some embodiments, the fluoropolymer/PAA blend of the electrode composition may include one or more fluoropolymers. The fluoropolymers may include one or more (co)polymers derived from polymerization of monomers comprising: at least two of tetrafluoroethylene (TFE), hexafluoropropylene (HFP), vinylidene fluoride (VDF), and chlorotrifluoroethylene (CTFE) and optionally polymerization of monomers comprising ethylene (E), propylene (P), or a modifier (as described below). In some embodiments, the (co)polymers may be derived from polymerization of monomers comprising TFE, HFP, and VDF. In various embodiments, the (co)polymers may be derived from polymerization of monomers comprising CTFE and one or more of VDF, HFP, E, P and a modifier (as described below).

In some embodiments, TFE derived monomeric units may be present in the (co)polymer in an amount of between 25 and 80 mole %, 30 and 65 mole %, or 35 and 55 mole %; HFP derived monomeric units may be present in the (co)polymer in an amount of between 1 and 22 mole %, 5 and 17 mole %, or 11 and 14 mole %; VDF derived monomeric units may be present in the (co)polymer in an amount of between 25 and 80 mole %, 40 and 60 mole %, or 36 and 51 mole %; and E or P derived monomeric units (individually or in combination) may be present in an amount of 20 to 60 mole % or 30 to 50 mole %. In some embodiments, CTFE derived monomeric units may be present in the (co)polymer in an amount of 2-95 mol %, 10-80 mol %, or 25-60 mol %; VDF derived monomeric units may be present in the (co)polymer in an amount of 1-75 mol %, 5-20 mol %, or 30-70 mol %, HFP derived monomeric units may be present in the (co)polymer in an amount of 0-30 mol %, 1-20 mol %, or 5-15 mol %; and E or P derived monomeric units may be present in the (co)polymer in an amount of 0-60 mol %, 5-50 mol %, or 10-45 mol %.

In some embodiments, the modifiers may include perfluorinated vinyl- or allylethers such as CF₂═CF—(CF₂)ₙ—O—R_{f}, where n=0 or 1, and R_{f} is a linear or branched C₁-C₁₀ perfluorinated alkyl group, which may be interrupted by additional oxygen atoms. Examples of particular modifiers include CF₂═CF—O—CF₃, CF₂═CF—O—C₂F₅/CF₂═CF—O—C₃F₇ (PPVE), CF₂═CF—O(CF₂)₃—OCF₃, CF₂═CF—CF₂—O—CF₃, CF₂═CF—CF₂—O—C₂F₅/C₃F₇, and CF₂═CF—CF₂—O—(CF₂)₃—OCF₃. The modifiers may also contain functional groups such as —SO₂F and —SO₃X, where X=H, Li, or Na. The modifier derived monomeric units may be present in an amount of 0.1-10 mole %, 0.5-6 mole %, or 1-5 mole %.

In some embodiments, the fluoropolymers may be prepared by aqueous emulsion polymerization using, for example, water soluble initiators (e.g., KMnO₄, potassium persulfate, or ammonium persulfate). Persulfates can also be applied either alone or in the presence of reducing agents (e.g. bisulfites). The concentration of initiators can vary from 0.001 w % to 5 wt. % based on the aqueous polymerization medium. In some embodiments, buffers may be employed (e.g. phosphates, acetate, carbonates) in an amount of 0.01-5 wt. %, based on the aqueous polymerization media. Chain-transfer agents like H₂, CBr₄, alkanes, alcohols, ethers, and esters may be used to tailor the molecular weight. The polymerization temperatures may be in the range of 20° C. to 100° C. or 30-90° C. at polymerization pressures of 0.4-2.5 MPa or 0.5-2 MPa. Fluorinated or perfluorinated emulsifiers may be used during polymerization, e.g., CF₃—O—CF₂—CF₂—CF₂—O—CHF—CF₂COONH₄. The polymers can also be made by using non-fluorinated emulsifiers. The solid content of the fluoropolymers of the obtained aqueous latices may be between 10-40 wt. %. The latices can be used as obtained or alternatively can be further up-concentrated, e.g. by ultra-filtration or thermal concentration, to solid contents of 40-60 wt. %. The fluoropolymers may be amorphous (having no melting point detectable in DSC-measurements) or they might have melting points up to 280° C. or between 100° C. to 260° C.

In some embodiments, the one or more fluoropolymers may be present in the fluoropolymer/PAA blend in an amount of between 15 and 85 wt. %, 30 and 70 wt. %, 40 and 60 wt. %, or 45 and 55 wt. %, based on the total weight of the fluoropolymer, PAA, and Li-PAA in the blend. In some embodiments, the one or more fluoropolymers may be hydrophobic.

In some embodiments, the fluoropolymer/PAA blend may include PAA, Li-PAA, or a combination thereof. In some embodiments, the PAA or Li-PAA may be present as a (co)polymer(s) derived from polymerization of monomers comprising (meth)acrylic acid or lithium (meth)acrylate (such (co)polymer may be referred to herein as an acylic acid based (co)polymer). In various embodiments, the acylic acid based (co)polymer may have a weight average molecular weight less than 1000 kD, less than 900 kD, less than 800 kD, less than 700 kD, or less than 600 kD; or between 5 kD and 900 kD, between 5 kD and 750 kD, or between 5 kD and 590 kD. For purposes of this disclosure, as it relates to the acylic acid based (co)polymer(s), the weight average molecular weights are based on aqueous gel permeation chromatography results obtained in an aqueous solution of 0.2 M NaNO₃/0.01 M NaH₂PO₄ adjusted to pH 7 and the do/dc of 0.231 mL/g for poly(acrylic acid) in water.

In some embodiments, the acylic acid based (co)polymer may be further derived from polymerization of one or more additional monomers such as acrylonitrile or alkyl (meth)acrylate, such as described in U.S. Pat. No. 7,875,388, the disclosure of which is herein incorporated by reference in its entirety. In some embodiments, in order to maintain water solubility of the acrylic acid based (co)polymer, the (meth)acrylic acid or lithium (meth)acrylate derived monomeric units (individually or in combination) may be present in the acylic acid based (co)polymer in an amount of at least 70 wt. %, at least 80 wt. %, or at least 90 wt. %, based on the total weight of the acrylic acid based (co)polymer. In various embodiments, the acylic acid based (co)polymer may have a composition of 60-80 wt % (meth)acrylic acid or lithium (meth)acrylate derived monomeric units, and 20-40 wt. % acrylonitrile derived monomeric units, based on the total weight of the acrylic acid based (co)polymer.

In some embodiments, lithium (meth)acrylate derived monomeric units may be present in the acylic acid based (co)polymer in an amount of between 0.1 and 50 wt. %, 2 and 40 wt. %, 4 and 25 wt. %, or 5 and 15 wt. %, based on the total weight of lithium (meth)acrylate derived monomeric units and acrylic acid derived monomeric units in the acylic acid based (co)polymer.

In some embodiments, fluoropolymer/PAA blend may be produced by combining a solution (e.g., aqueous solution) of PAA or Li-PAA and a dispersion (e.g, aqueous dispersion) of the one or more fluoropolymers. Surprisingly, it has been discovered that upon such blending, precipitation, as has been observed with higher molecular weight PAA or Li-PAA, did not occur. The fluoropolymer dispersion may include, in addition to the fluoropolymer, other additives such as dispersion aids, surfactants, pH control agents, biocides, cosolvents, and the like.

In some embodiments, aqueous fluoropolymer dispersions may include (co)polymers derived from polymerization of TFE, HFP, and VDF (“THV compositions”), with TFE derived monomeric units ranging from 30-80 mole %, HFP derived monomeric units ranging from 10-20 mole %, VDF derived monomeric units ranging from 30-55 mole %, and modifier (e.g. CF₂═CF—OC₃F₇) derived monomeric unit ranging from 0-5 mole %. In illustrative embodiments, a THV composition includes TFE derived monomeric units in an amount of 35-60 mole %, HFP derived monomeric units in an amount of 10-18 mole %, VDF derived monomeric units in an amount of 32-55 mole %, and modifier derived monomeric units of 0-3 mole %.

In various embodiments, the solid content of the fluoropolymer dispersions may be between 10-60 wt. %, or 20-55 wt. %. The pH-values may be between 2 and 7, but can be adjusted by adding acids, caustic, or buffers. The aqueous fluoropolymer dispersion can comprise fluorinated surfactants (ed.g. ADONA), hydrocarbon surfactants with polar groups (e.g. SO₃⁻, —OSO₃⁻, and carboxylates or carboxylic acids such as lauric acid) and can contain non-ionic surfactants (e.g. Triton X 100, Tergitols, Genapols, Glucopon). The contents of these adjuvants may be between 50 ppm and 5 wt. % based on the amount of water.

In some embodiments, the fluoropolymer dispersion may also contain organic water-miscible cosolvents in amounts up to a total of 25 wt %. Such cosolvents include lower alcohols such as methanol, ethanol, and ispropyl alcohol, alcohol ethers such as 1-methoxy-2-propanol, ethers such as ethylene glycol dimethyl or diethyl ethers, N-methylpyrrolidinone, dimethyl sulfoxide, and N, N-dimethylformamide.

In some embodiments, the fluoropolymer dispersion may include, or consist essentially of the THV composition employed in Fluoropolymer Dispersion 2 in Table 1 of the present application.

In some embodiments, after combining the fluoropolymer dispersion and the PAA dispersion, the resulting fluoropolymer/PAA dispersion may be partially neutralized by the addition of a suitable base material (e.g, lithium hydroxide) to a pH of between 3 and 4. Surprisingly, it has been discovered that upon such partial neutralization, precipitation, as has been observed with various other fluoropolymers, did not occur.

In some embodiments, the fluoropolymer/PAA dispersion may then be dried, using any conventional drying technique, to form the fluoropolymer/PAA blend of the present disclosure. Surprisingly, it has been discovered that the fluoropolymer/PAA blends of the present disclosure, after drying, exhibit greatly improved flexibility and resistance to flexing than the dried, neat forms of PAA and LiPAA, which exhibit severe cracking or even shattering when deformed.

In some embodiments, the fluoropolymer/PAA blend may be present in the negative electrode composition in an amount of between 1 and 20 wt. %, 3 and 15 wt. %, 5 and 12 wt. %, or 8 and 11 wt. %, based on the total weight of the negative electrode composition.

In some embodiments, the fluoropolymer/PAA blend may be present in the electrode composition as a binder. As used herein, in the context of an electrode composition, the term “binder” refers a material that functions to produce or promote cohesion in the loosely assembled substances that form the electrode composition. In this regard, in some embodiments the fluoropolymer/PAA blend may be uniformly dispersed throughout the negative electrode composition. Alternatively, or additionally, the fluoropolymer/PAA blend may be present as a coating that surrounds a portion (up to the entirety) of the electrochemically active material (e.g, silicon alloy particles).

In some embodiments, the negative electrode compositions of the present disclosure may also include one or more additives such as binders, conductive diluents, fillers, adhesion promoters, dispersion aids, thickening agents for dispersion viscosity modification, or other additives known by those skilled in the art. In illustrative embodiments, the negative electrode compositions may include an electrically conductive diluent to facilitate electron transfer from the composition to a current collector. Electrically conductive diluents include, for example, carbons, conductive polymers, powdered metal, metal nitrides, metal carbides, metal silicides, and metal borides, or combinations thereof. Representative electrically conductive carbon diluents include carbon blacks such as Super P and Super S carbon blacks (both from Timcal, Switzerland), Shawinigan Black (Chevron Chemical Co., Houston, Tex.), acetylene black, furnace black, lamp black, graphite, carbon fibers, and combinations thereof. In some embodiments, the conductive carbon diluents may include carbon nanotubes. In some embodiments, the amount of conductive diluent (e.g., carbon nanotubes) in the electrode composition may be at least 2 wt. %, at least 6 wt. %, or at least 8 wt. %, or at least 20 wt. % based upon the total weight of the electrode coating; or between 0.2 wt. % and 80 wt. %, between 0.5 wt. % and 50 wt. %, between 0.5 wt. % and 20 wt. %, or between 1 wt. % and 10 wt. %, based upon the total weight of the negative electrode composition.

In some embodiments, the negative electrode compositions may include graphite to improve the density and cycling performance, especially in calendered coatings, as described in U.S. Patent Application Publication 2008/0206641 by Christensen et al., which is herein incorporated by reference in its entirety. The graphite may be present in the negative electrode composition in an amount of greater than 10 wt. %, greater than 20 wt. %, greater than 50 wt. %, greater than 70 wt. % or even greater, based upon the total weight of the negative electrode composition; or between 20 wt. % and 90 wt. %, between 30 wt. % and 80 wt. %, between 40 wt. % and 60 wt. %, between 45 wt. % and 55 wt. %, between 80 wt. % and 90 wt. %, or between 85 wt. % and 90 wt. %, based upon the total weight of the electrode composition.

In some embodiments, the present disclosure is further directed to negative electrodes for use in lithium ion electrochemical cells. The negative electrodes may include a current collector having disposed thereon the above-described negative electrode composition. The current collector may be formed of a conductive material such as a metal (e.g., copper, aluminum, nickel), or a carbon composite.

In some embodiments, the present disclosure further relates to lithium-ion electrochemical cells. In addition to the above-described negative electrodes, the electrochemical cells may include a positive electrode, an electrolyte, and a separator. In the cell, the electrolyte may be in contact with both the positive electrode and the negative electrode, and the positive electrode and the negative electrode are not in physical contact with each other; typically, they are separated by a polymeric separator film sandwiched between the electrodes.

In some embodiments, the positive electrode composition may include an active material. The active material may include a lithium metal oxide. In an exemplary embodiment, the active material may include lithium transition metal oxide intercalation compounds such as LiCoO₂, LiCo_{0.2}Ni_{0.8}O₂, LiMn₂O₄, LiFePO₄, LiNiO₂, or lithium mixed metal oxides of manganese, nickel, and cobalt in any effective proportion, or of nickel, cobalt, and aluminum in any effective proportion. Blends of these materials can also be used in positive electrode compositions. Other exemplary cathode materials are disclosed in U.S. Pat. No. 6,680,145 (Obrovac et al.) and include transition metal grains in combination with lithium-containing grains. Suitable transition metal grains include, for example, iron, cobalt, chromium, nickel, vanadium, manganese, copper, zinc, zirconium, molybdenum, niobium, or combinations thereof with a grain size no greater than about 50 nanometers. Suitable lithium-containing grains can be selected from lithium oxides, lithium sulfides, lithium halides (e.g., chlorides, bromides, iodides, or fluorides), or combinations thereof. The positive electrode composition may further include additives such as binders (such as polymeric binders (e.g., polyvinylidene fluoride), conductive diluents (e.g., carbon, carbon black, flake graphite, carbon nanotubes, conductive polymers), fillers, adhesion promoters, thickening agents for coating viscosity modification such as carboxymethylcellulose, or other additives known by those skilled in the art. In various embodiments, useful electrolyte compositions may be in the form of a liquid, solid, or gel. The electrolyte compositions may include a salt and a solvent (or charge-carrying medium). Examples of liquid electrolyte solvents include ethylene carbonate, dimethyl carbonate, ethyl methyl carbonate, diethyl carbonate, propylene carbonate, fluoroethylene carbonate, tetrahydrofuran (THF), acetonitrile, and combinations thereof. In some embodiments the electrolyte solvent may comprise glymes, including monoglyme, diglyme and higher glymes, such as tetraglyme. Examples of suitable lithium electrolyte salts include LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, and combinations thereof.

In some embodiments, the lithium-ion electrochemical cells may further include a microporous separator, such as a microporous material available from Celgard LLC, Charlotte, N.C. The separator may be incorporated into the cell and used to prevent the contact of the negative electrode directly with the positive electrode.

The disclosed lithium ion electrochemical cells can be used in a variety of devices including, without limitation, portable computers, tablet displays, personal digital assistants, mobile telephones, motorized devices (e.g., personal or household appliances, power tools and vehicles), instruments, illumination devices (e.g., flashlights) and heating devices. Multiple lithium ion electrochemical cells of this disclosure can be combined to provide a battery pack.

The present disclosure further relates to methods of making the above-described electrochemically active materials. In some embodiments, the alloy material can be made by methods known to produce films, ribbons, or particles of metals or alloys including cold rolling, arc melting, resistance heating, ball milling, sputtering, chemical vapor deposition, thermal evaporation, atomization, induction heating or melt spinning. The above described active materials may also be made via the reduction of metal oxides or sulfides. In some embodiments, the alloy material can be made in accordance with the methods of U.S. Pat. Nos. 7,871,727, 7,906,238, 8,071,238, or U.S. Pat. No. 8,753,545, which are each herein incorporated by reference in their entirety. Any desired coatings may be applied to the alloy material by milling, solution deposition, vapor phase processes, or other processes known to those of ordinary skill in the art. In embodiments in which the coating includes a carbonaceous material or non-metallic, electrically conductive layer, such coating may be applied in accordance with the methods of U.S. Pat. No. 6,664,004, which is herein incorporated by reference in its entirety.

The present disclosure further relates to methods of making negative electrodes that include the above-described negative electrode compositions. In some embodiments, the method may include mixing the above-described electrochemically active materials and fluoropolymer/PAA blends, along with any additives such as binders, conductive diluents, fillers, adhesion promoters, thickening agents, in a suitable coating solvent such as water or N-methylpyrrolidinone or a mixture thereof to form a coating dispersion or coating mixture. The dispersion may be mixed thoroughly and then applied to a foil current collector by any appropriate coating technique such as knife coating, notched bar coating, dip coating, spray coating, electrospray coating, or gravure coating. The current collectors may be thin foils of conductive metals such as, for example, copper, aluminum, stainless steel, or nickel foil. The slurry may be coated onto the current collector foil and then allowed to dry in air or vacuum, and optionally by drying in a heated oven, typically at about 80° to about 300° C. for about an hour to remove the solvent.

The present disclosure further relates to methods of making lithium ion electrochemical cells. In various embodiments, the method may include providing a negative electrode as described above, providing a positive electrode that includes lithium, and incorporating the negative electrode and the positive electrode into an electrochemical cell comprising a lithium-containing electrolyte.

### Listing of Embodiments

1. A negative electrode material comprising:

a silicon containing material; and

a composition comprising: (i) a first (co)polymer derived from polymerization of two or more monomers comprising tetrafluoroethylene, hexafluoropropylene, vinylidene fluoride, or chlorotrifluorethylene; and (ii) a second (co)polymer derived from polymerization of monomers comprising (meth)acrylic acid or lithium (meth)acrylate.

2. The negative electrode material of embodiment 1, wherein the silicon containing material has a volumetric capacity greater than 1000 mAh/ml.
3. The negative electrode material of any one of the previous embodiments, wherein the silicon containing material comprises alloy material comprising particles having the formula: SiₓM_{y}C_{z}, where x, y, and z represent atomic % values and (a) x+y+z=100%; (b) x>2y+z; (c) x and y are greater than 0; z is equal to or greater than 0; and (d) M is iron and optionally one or more metals selected from manganese, molybdenum, niobium, tungsten, tantalum, copper, titanium, vanadium, chromium, nickel, cobalt, zirconium, and yttrium.
4. The negative electrode material of embodiment 3, wherein 65%≤x≤85%, 5%≤y≤20%, and 5%≤z≤15%.
5. The negative electrode material of any one of the previous embodiments, further comprising graphite in an amount of between 20 and 90 wt. %, based on the total weight of the negative electrode material.
6. The negative electrode material of any one of the previous embodiments, wherein tetrafluoroethylene derived monomeric units are present in the first (co)polymer in an amount of between 25 and 80 mole %, hexafluoropropylene derived monomeric units are present in the first (co)polymer in an amount of between 5 and 22 mole %, and vinylidene fluoride derived monomeric units are present in the first (co)polymer an amount of between 25 and 80 mole %, based on the total moles of the first (co)polymer.
7. The negative electrode material of any one of the previous embodiments, wherein CTFE derived monomeric units are be present in the first (co)polymer in an amount of 2 and 95 mole %, VDF derived monomeric units are be present in the first (co)polymer in an amount of 1-75 mole %, and HFP derived monomeric units are present in the first (co)polymer in an amount of 0-30 mole %, based on the total moles of the first (co)polymer.
8. The negative electrode material of any one of the previous embodiments, wherein the first (co)polymer is present in the composition in an amount of between 30 and 60 wt. %, based on the total weight of the first and second (co)polymers in the composition.
9. The negative electrode material of any one of the previous embodiments, wherein the second (co)polymer has a weight average molecular weight less than 1000 kD.
10. The negative electrode material of any one of the previous embodiments, wherein lithium (meth)acrylate derived monomeric units are present in the second (co)polymer in an amount of between 2 and 40 wt. %, based on the total weight of lithium (meth)acrylate derived monomeric units and acrylic acid derived monomeric units in the second (co)polymer.
11. The negative electrode material of any one of the previous embodiments, wherein the composition is present in the negative electrode material in an amount of between 1 and 20 wt. %, based on the total weight of the negative electrode material.
12. The negative electrode material of any one of the previous embodiments, wherein the composition is uniformly dispersed throughout the negative electrode material.
13. A negative electrode comprising:

the negative electrode material according to any one of the previous embodiments; and

a current collector. 14. An electrochemical cell comprising:

the negative electrode of embodiment 13;

a positive electrode comprising a positive electrode composition comprising lithium; and

an electrolyte comprising lithium.

15. An electronic device comprising the electrochemical cell according to embodiment 14.
16. A method of making an electrochemical cell, the method comprising:

providing a positive electrode comprising a positive electrode composition comprising lithium;

providing a negative electrode according to embodiment 13;

providing an electrolyte comprising lithium; and

incorporating the positive electrode, negative electrode, and the electrolyte into an electrochemical cell.

The operation of the present disclosure will be further described with regard to the following detailed examples. These examples are offered to further illustrate various specific embodiments and techniques. It should be understood, however, that many variations and modifications may be made while remaining within the scope of the present disclosure.

### EXAMPLES

The following examples are offered to aid in the understanding of the present disclosure and are not to be construed as limiting the scope thereof. Unless otherwise indicated, all parts and percentages are by weight. All materials were obtained from Sigma-Aldrich Corporation, USA and used as received, unless otherwise indicated.

Materials Used

| Material | Description | Source |
|---|---|---|
| DYNEON THY | fluorinated | 3M Company, USA |
| 340Z | (co)polymer dispersion | |
| DYNEON ADONA | fluorinated emulsifier | 3M Company, USA |
| GENAPOL LRO | hydrocarbon emulsifier | Clariant, USA |
| CARBOSPERSE K- | polyacrylic acid | Lubrizol Corporation, USA |
| 7058 | (co)polymer | |
| CARBOSPERSE K- | polyacrylic acid | Lubrizol Corporation, USA |
| 702 | (co)polymer | |
| DOWEX | Ion exchange resin | Dow Chemical Company, |
| MONOSPHERE | | USA |
| 650C (H) | | |

### Preparation of Fluoropolymer/PAA Blend Dispersions

### Preparatory Example 1—Synthesis of Low Molecular Weight Polyacrylic Acid (PAA) Solution

A 32 oz. (1 L) screw-top reaction bottle, was charged with 100 parts of AA, 400 parts of DI water, 0.5 parts of CBr₄ chain transfer agent and 0.5 parts of V-50 initiator. The solution was purged with nitrogen for 2 minutes and sealed. The bottle was placed in a rotary water bath at 50° C. for 21 hours. The reaction bottle was taken out and cooled to room temperature. A clear viscous polymer solution was obtained. Gravimetric analysis revealed complete monomer conversion. The solids content was adjusted to 10 wt % PAA by further addition of deionized water.

### Preparatory Example 2—Synthesis of High Molecular Weight Polyacrylic Acid (PAA) Solution

A 32 oz. (1 L) screw-top reaction bottle was charged with 50 parts of AA, 450 parts of DI water, and 0.125 parts of potassium persulfate initiator. The solution was purged with nitrogen for 2 minutes and sealed. The bottle was placed in a rotary water bath at 60° C. for 21 hours. The reaction bottle was taken out and cooled to room temperature. A clear viscous polymer solution was obtained. Gravimetric analysis revealed complete monomer conversion.

### Preparatory Examples 3 & 4

Commercially available polyacrylic acid (co)polymers CARBOSPERSE K-7058 and CARBOSPERSE K-702 were purchased from Lubrizol Corporation, USA and used as received.

The molecular weight of each of the PAA samples was as follows:

| Preparatory | | |
|---|---|---|
| Example Number | Designation | MW (kD) |
| Example 1 | PAA-1 | 194 |
| Example 2 | PAA-2 | 1000 |
| Example 3 | CARBOSPERSE K-7058 | 5 |
| Example 4 | CARBOSPERSE K-702 | 590 |

### Preparatory Example 5—Fluoropolymer Dispersions

The fluoropolymer dispersions are described in Table 1 below. Fluoropolymer Dispersion 1 was obtained from 3M Company, MN, USA and used as received.

The compositions of the fluorinated (co)polymer Dispersions 2-9 are summarized in Table 1, and were prepared as follows.

To prepare Fluoropolymer Dispersion 2, a 52 liter (L) stainless steel reactor was charged with a solution of 30 L of demineralized water, 60 g ammonium oxalate [(NH₄)₂C₂O₄×1 H₂O], 30 g oxalic acid and 0.050 kg of 28 wt % GENAPOL LRO. The oxygen-free reactor was heated to 60° C. and was pressurized with ethane to 0.370 bar, with TFE up to 2.0 bar, with HFP up to 8.6 bar, with VDF up to 14.0 bar, and finally with TFE again up to 17 bar. The polymerization was initiated by adding 1.1 kg of a 2 wt % KMnO₄ solution. After 4.5 hours the polymerization was stopped, at which point 6.0 kg of TFE, 2.58 kg of HFP, and 5 kg of VDF were introduced to the reactor. The latex was treated with DOWEX MONOSPHERE 650 C (H) ion exchange resin to remove the cations.

To prepare Fluoropolymer Dispersions 3 and 4, a 52 L reactor was charged with 30 L H₂O, 13 g ammonium oxalate, 2 g oxalic acid×2 H₂O, and 0.29 kg of a 30 wt % ADONA solution. The 60° C. heated reactor was pressurized with ethane to 1.2 bar, with TFE to 2 bar, with HFP to 8.6 bar, with VDF to 14 bar, and finally with TFE to 17 bar. The polymerization was initiated with 0.27 kg of a 1.0 wt % KMnO₄ solution. After 3.2 hours, 7.2 kg of TFE, 6.3 kg of VDF, 2.4 kg of HFP were fed to the reactor. For Fluoropolymer Dispersion 3, the latex was treated with DOWEX MONOSPHERE 650 C (H) ion-exchange resin to remove cations. No ion exchange was performed for Fluoropolymer Dispersion 4.

Fluoropolymer Dispersion 5 was prepared in aqueous media with no emulsifier at a polymerization temperature of 60° C. and with ammonium persulfate as initiator.

Fluoropolymer Dispersion 6 was prepared as follows. A 52 L-kettle was charged with 30 L H₂O, 60 g ammonium oxalate, 25 g oxalic acid, 1.3 g tert butanol, 0.54 kg 30 wt % ADONA solution and 60 g diethyl malonate. The polymerization temperature was 31° C.; the pressure was 17 bar; and 7.5 kg TFE, 2.1 kg ethylene, 0.37 kg HFP and 0.4 kg PPVE were fed over 3.7 hours. Cations were removed by ion-exchange as described for Fluoropolymer Dispersions 2 and 3.

Fluoropolymer Dispersion 7 was prepared using the same polymerization conditions as described for Fluoropolymer Dispersion 3 with monomers amounts adjusted to achieve the desired composition.

Fluoropolymer Dispersion 8 was prepared using the same polymerization conditions as described for Fluoropolymer Dispersion 2, except that PPVE (CF₂═CF—O—C₃F₇) was sprayed into the polymerization continuously, and amounts of TFE, HFP, VDF, and PPVE were adjusted to achieve the desired composition.

Fluoropolymer Dispersion 9 was prepared as described for Fluoropolymer Dispersion 8, but the cations were removed with an ion-exchange resin as described for Fluoropolymer Dispersion 2.

If visible solid particulates were present in any of the dispersions, the materials were filtered via gravity filtration through WHATMAN #4 filter funnels (Maidstone, UK). Percent solids measurements were performed on the dispersions as received by gravimetry and heating in aluminum pans at 120° C. for 30 min in a forced-air oven. pH measurements were performed using pH test strips (range 0-14, Ricca Chemical Co., USA.) After filtration (if necessary) and pH measurement, samples of the fluoropolymer dispersions were diluted to 10 wt % solids by the addition of deionized water. The resulting 10 wt % solids dispersions were all clear to slightly hazy after dilution.

TABLE 1
Fluoropolymer Dispersions

| Fluoropolymer | | | | |
|---|---|---|---|---|
| Dispersion | | | Wt % | |
| Number | (Co)Polymer | Composition | Solids | pH |
| 1 | DYNEON THV | (co)polymer of 50 mole % TFE, | 51.8 | 9-10 |
| | 340Z | 13 mole % HFP, and 37 mole % | | |
| | | VDF | | |
| 2 | THV | (co)polymer of 37 mole % TFE, | 26.9 | 2-3 |
| | (Co)polymer | 12 mole % HFP, and 51 mole % | | |
| | | VDF | | |
| 3 | THV | (co)polymer of 37 mole % TFE, | 35.6 | 2-3 |
| | (Co)polymer | 12 mole % HFP, and 51 mole % | | |
| | | VDF | | |
| 4 | THV | (co)polymer of 37 mole % TFE, | 39.8 | 7 |
| | (Co)polymer | 12 mole % HFP, and 51 mole % | | |
| | | VDF | | |
| 5 | VDF/HFP- | (co)polymer of 38 mole % HFP, | 27.3 | 2-3 |
| | (Co)polymer | 61 mole % VDF, and 1 mole % | | |
| | | CF₂═CF—O—(CF₂)₄SO₂F | | |
| 6 | ETFE | (co)polymer of 49 mole % TFE, | 24.9 | 6-7 |
| | (Co)polymer | 48.5 mole % E, 1.5 mole % HFP, | | |
| | | and 1 mole % CF₂═CF—O—C₃F₇ | | |
| 7 | THV | (co)polymer of 55 mole % TFE, | 39.5 | 6-7 |
| | (Co)polymer | 12 mole % HFP, and 32 mole % | | |
| | | VDF | | |
| 8 | THV | (co)polymer of 46 mole % TFE, | 31.4 | 6-7 |
| | (Co)polymer | 17 mole % HFP, 35 mole % VDF, | | |
| | | and 2 mole % CF₂═CF—O—C₃F₇ | | |
| 9 | THV | (co)polymer of 46 mole % TFE, | 33.1 | 4-5 |
| | (Co)polymer | 17 mole % HFP, 35 mole % VDF, | | |
| | | and 2 mole % CF₂═CF—O—C₃F₇ | | |

### Illustrative Examples 6-15 and Comparative Examples CE1 and CE3

A series of small glass screw-top vials were charged with 1 g of the 10 wt % dilutions of the fluoropolymer dispersions prepared in Example 5. To each vial was then added 1 g of the 10 wt % PAA solution of Examples 1 through 4. The vials were shaken to mix the components, then visually inspected for haze (evidence of phase separation) or development of precipitate. None of the samples produced visible liquid phase separation with low molecular weight PAA. Results are summarized in Table 2.

TABLE 2
Miscibility Results

| | Fluoropolymer | | | |
|---|---|---|---|---|
| | Dispersion | | Liquid | |
| Example | from Table 1 | PAA Type | Appearance | Precipitate |
| CE1 | 1 | PAA-1 | Clear | Voluminous |
| CE2 | 2 | PAA-2 | Phase Separated | Yes |
| 6 | 2 | PAA-1 | Slightly Hazy | None |
| 7 | 3 | PAA-1 | Very slightly | None |
| | | | hazy | |
| 8 | 4 | PAA-1 | Very slightly | None |
| | | | hazy | |
| 9 | 5 | PAA-1 | Slightly hazy | None |
| 10 | 6 | PAA-1 | Hazy | None |
| 11 | 7 | PAA-1 | Slightly hazy | None |
| 12 | 8 | PAA-1 | Clear | None |
| 13 | 9 | PAA-1 | Clear | None |
| 14 | 2 | CARBOSPERSE | Slightly hazy | None |
| | | K-7058 | | |
| 15 | 2 | CARBOSPERSE | Slightly hazy | None |
| | | K-702 | | |

### Illustrative Examples 16-17 and Comparative Examples CE3-CE4

A portion of filtered Fluoropolymer Dispersion 2 was diluted with deionized water to give a stable 10 wt % dispersion (Comparative Example CE3). The dilution showed pH˜3.5 as measured by pH test strips as described above.

A sample of THV 340Z Fluoropolymer Dispersion 1 was diluted with deionized water to give a stable 10 wt % dispersion (Comparative Example CE4). The dilution showed pH 8-9 as measured by pH test strips.

The dispersion of Example 16 was prepared as described above for Example 6. This gave a hazy dispersion with pH˜3 as measured by pH test strips, and solids content of 9.8 wt % by gravimetry using methods described in Example 5. The dispersion for Example 17 was prepared by treating a portion of the dispersion of Example 16 with drops of a 10 wt % solution of lithium hydroxide monohydrate in deionized water until the pH of the mixture was 3.6-3.9 as measured by pH test strips. This yielded a hazy dispersion. Gravimetric analysis using the method described in Example 5 gave a solids content of 9.6 wt %.

The dispersions of Examples 16 and 17 were dried in an aluminum pan to remove the water. The residues from this drydown process of the dispersions of Examples 16 and 17 showed much greater flexibility on bending of the aluminum sample pans than did dried solids from polyacrylic acid or LiPAA solutions, which shattered upon flexing.

### Preparation of Anode Coatings and Coin Half-Cells

### Electrolyte

The electrolyte used in half-cell preparation was a mixture of 90 wt % of a 1 M solution of LiPF₆ in 3:7 (w/w) ethylene carbonate:ethyl methyl carbonate (SELECTILYTE LP 57 available from BASF, USA) and 10 wt % monofluoroethylene carbonate (also available from BASF).

### Preparation of Electrode Alloy Slurry

The materials of Illustrative Examples 16 and 17 and Comparative Examples CE3 and CE4, were used as binders for the preparation of silicon alloy electrodes. Comparative Example CE5 was a 10 wt % solution of lithium polyacrylate prepared by neutralization of poly(acrylic acid) (PAA, MW 250,000, from Sigma Aldrich, USA) with lithium hydroxide monohydrate to a pH of 7.

32 Yttria-Stabilized Zirconia (YSZ) milling media beads (6.5 mm diameter, available from American Elements, Los Angeles, Calif.) were placed in a 45-ml tungsten carbide vessel (available from Fritsch GmbH, Idon-Oberstein, Germany). Silicon alloy composite particles having the formula Si_{75.42}Fe_{13.89}C_{10.70} were prepared using procedures disclosed in U.S. Pat. Nos. 8,071,238 and 7,906,238, after which the alloy particles were coated with nano-carbon. 1.82 grams of silicon alloy composite particles and 1.80 grams of 10% solids binder solution (one of Examples 16, 17, CE3, CE4, or CE5) were then added to the vessel, after which a preliminary mix and viscosity check were performed. If necessary to achieve a coatable viscosity, more deionized water was added. The vessel was then covered, and the slurry was mixed for one hour in a planetary micro mill (PULVERISETTE 7, available from Fritsch GmbH, Idon-Oberstein, Germany) at speed setting #2.

### Coating of Electrode

The electrode slurries were then coated onto copper foil to prepare working electrodes, using the following procedure. First, a bead of acetone was dispensed on a clean glass plate and overlaid with a sheet of 15 micron copper foil (available from Furukawa Electric, Japan), which was cleaned with acetone. Using a 3-mil (0.076 mm), 4-mil (0.10 mm), or 5 mil (0.13 mm) coating bar and a steel bar guide, the slurry was dispensed onto the coating bar and drawn down in a steady motion. The composite anode coating was then allowed to dry under ambient conditions for 1 hour, after which it was transferred to a dry room with a dew point below −40° C. The coated foil was then dried in a vacuum oven at 120° C. for 2 hours.

### Coin Cell Preparation

To prepare half coin cells, working electrodes were punched from the coated copper foil face down, with white paper underneath, using a 16 mm die, and then the paper was removed. Three matching copper foil pieces were punched (bare current collector) and the average mesh weight was determined. Films of CELGARD 2325 separator material (25 micron microporous trilayer PP/PE/PP membrane, Celgard, USA) were placed between sheets of colored paper and punched out using a 20 mm die, removing the paper afterwards. For each cell, at least 2 separators were cut. Both sides of a lithium foil sheet were rolled and brushed, placed between sheets of plastic film, and counter electrodes were punched out using an 18 mm die, after which the plastic film was removed. Each electrode was weighed separately and the total weight was recorded.

Electrochemical 2325 coin cells were then assembled in this order: 2325 coin cell bottom, 30 mil copper spacer, lithium counter electrode, 33.3 microliters electrolyte, separator, 33.3 microliters electrolyte, separator, grommet, 33.3 microliters electrolyte, working electrode (face down and aligned with lithium counter electrode), 30 mil copper spacer, 2325 coin cell top. The cell was crimped and labelled.

### Characterization of Electrochemical Performance

The coin cells were then cycled using a SERIES 4000 Automated Test System (available from Maccor Inc, USA) according to the following protocol.

Cycle 1: Discharge to 0.005V at C/10, trickle discharge to C/40 followed by 15 minutes rest. Charge to 0.9V at C/10 followed by 15 min rest.

Cycles 2-100: Discharge to 0.005V at C/4, trickle discharge to C/20 followed by 15 min rest. Charge to 0.9V at C/4 followed by 15 min rest.

The discharge capacity retention over the 100 test cycles was recorded and plotted.

Electrochemical Cycling Results of Half-Cells Prepared Using Binders from Illustrative Examples 16 and 17 and Comparative Examples CE3-CE5

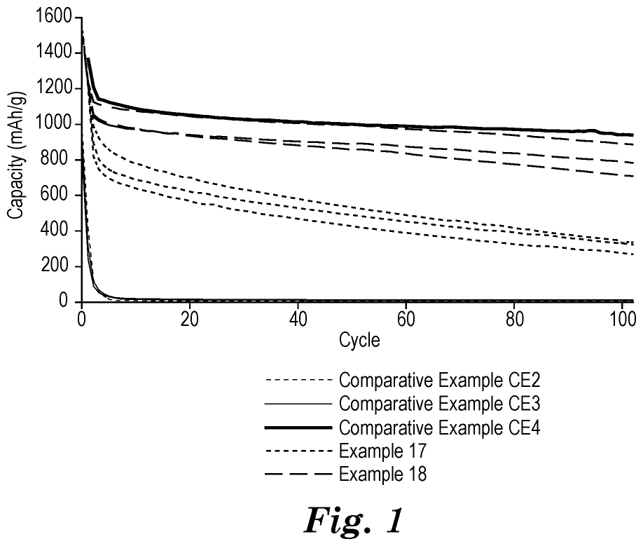

FIG. 1 shows discharge capacity as a function of cycle number for lithium half cell replicates prepared as described earlier using binders from Examples 16 and 17 and Comparative Examples CE3, CE4, and CE5. Example 17 showed capacity retention similar to that for CE5 over the 100 cycles of testing. Comparative Examples CE3 and CE4 showed extremely poor performance as binders, while Example 16, although it showed more fade than Example 17, was nevertheless far better than the Comparative Examples.

Moisture Pickup Measurements on Electrode Coatings with Binders from Illustrative Example 17 and CE5

Fresh coin cell electrodes with coatings of silicon alloy electrodes prepared using the above procedures and either Example 17 (four replicate samples) or LiPAA binder CE5 (three replicate samples) on copper foil were allowed to equilibrate to constant weight in a dry room with dew point below −40° C. Weights were noted after subtraction of the copper foil carrier tares. Samples were transferred into a constant temperature/humidity room controlled at 21° C. and 50% RH, and allowed to stand for five days after which time they were reweighed. The percent increase in anode coating weight due to moisture absorption was calculated and found to be 4.5-5.7 wt % for CE5 and 0.8-1.8 wt % for Example 17.

### Illustrative Examples 18-24

A sample of filtered Fluoropolymer Dispersion 2 was diluted with deionized water to give a stable 10 wt % dispersion (Comparative Example CE3). The dilution showed pH˜3.5 as measured by pH test strips. This diluted dispersion and the 10 wt % solution of low-MW PAA-1 (Preparatory Example 1) were used to prepare a series of Fluoropolymer:PAA blends at various weight ratios as shown in Table 3 below. Samples were prepared in glass screw-top vials, shaken to mix the components, allowed to stand overnight at room temperature, then visually inspected for haze and formation of particulates. Results are shown in Table 3.

TABLE 3

| | Fluoropolymer | | |
|---|---|---|---|
| | Dispersion 2:PAA-1 | Liquid | |
| Example | Weight Ratio | Appearance | Particulates |
| 18 | 15:85 | Clear | None |
| 19 | 25:75 | Clear | None |
| 20 | 50:50 | Very slightly Hazy | None |
| 21 | 60:40 | Very slightly Hazy | Slight |
| 22 | 70:30 | Slightly Hazy | Slight |
| 23 | 75:25 | Hazy | Slight |
| 24 | 85:15 | Hazy | Slight |

Although specific embodiments have been illustrated and described herein for purposes of description of some embodiments, it will be appreciated by those of ordinary skill in the art that a wide variety of alternate and/or equivalent implementations may be substituted for the specific embodiments shown and described without departing from the scope of the present disclosure.

What is claimed:

1. A negative electrode material comprising:
a silicon containing material; and
a composition comprising: (i) a first (co)polymer derived from polymerization of two or more monomers comprising tetrafluoroethylene, hexafluoropropylene, vinylidene fluoride, or chlorotrifluorethylene; and (ii) a second (co)polymer derived from polymerization of monomers comprising (meth)acrylic acid or lithium (meth)acrylate.

2. The negative electrode material of claim 1, wherein the silicon containing material has a volumetric capacity greater than 1000 mAh/ml.

3. The negative electrode material of claim 1, wherein the silicon containing material comprises an alloy material comprising particles having the formula: SiₓM_{y}C_{z}, where x, y, and z represent atomic % values and (a) x+y+z=100%; (b) x>2y+z; (c) x and y are greater than 0; z is equal to or greater than 0; and (d) M is iron and optionally one or more metals selected from manganese, molybdenum, niobium, tungsten, tantalum, copper, titanium, vanadium, chromium, nickel, cobalt, zirconium, and yttrium.

4. The negative electrode material of claim 3, wherein 65%≤x≤85%, 5%≤y≤20%, and 5%≤z≤15%.

5. The negative electrode material of claim 1, further comprising graphite in an amount of between 20 and 90 wt. %, based on the total weight of the negative electrode material.

6. The negative electrode material of claim 1, wherein tetrafluoroethylene derived monomeric units are present in the first (co)polymer in an amount of between 25 and 80 mole %, hexafluoropropylene derived monomeric units are present in the first (co)polymer in an amount of between 5 and 22 mole %, and vinylidene fluoride derived monomeric units are present in the first (co)polymer an amount of between 25 and 80 mole %, based on the total moles of the first (co)polymer.

7. The negative electrode material of claim 1, wherein CTFE derived monomeric units are be present in the first (co)polymer in an amount of 2 and 95 mole %, VDF derived monomeric units are be present in the first (co)polymer in an amount of 1-75 mole %, and HFP derived monomeric units are present in the first (co)polymer in an amount of 0-30 mole %, based on the total moles of the first (co)polymer.

8. The negative electrode material of claim 1, wherein the first (co)polymer is present in the composition in an amount of between 30 and 60 wt. %, based on the total weight of the first and second (co)polymers in the composition.

9. The negative electrode material of claim 1, wherein the second (co)polymer has a weight average molecular weight less than 1000 kD.

10. The negative electrode material of claim 1, wherein lithium (meth)acrylate derived monomeric units are present in the second (co)polymer in an amount of between 2 and 40 wt. %, based on the total weight of lithium (meth)acrylate derived monomeric units and acrylic acid derived monomeric units in the second (co)polymer.

11. The negative electrode material of claim 1, wherein the composition is present in the negative electrode material in an amount of between 1 and 20 wt. %, based on the total weight of the negative electrode material.

12. The negative electrode material of claim 1, wherein the composition is uniformly dispersed throughout the negative electrode material.

13. A negative electrode comprising:
the negative electrode material according to claim 1; and
a current collector.

14. An electrochemical cell comprising:
the negative electrode of claim 13;
a positive electrode comprising a positive electrode composition comprising lithium; and
an electrolyte comprising lithium.

15. An electronic device comprising the electrochemical cell according to claim 14.

16. A method of making an electrochemical cell, the method comprising:
providing a positive electrode comprising a positive electrode composition comprising lithium;
providing a negative electrode according to claim 13;
providing an electrolyte comprising lithium; and
incorporating the positive electrode, negative electrode, and the electrolyte into an electrochemical cell.
